(19) United States
(12) Patent Application Publication
(10) Pub. No.: US 2013/0312602 A1
(43) Pub. Date: Nov. 28, 2013

(54) FLUE GAS DIFFUSER OBJECTS

(71) Applicant: Dennis W. Johnson, Simpsonville, SC (US)

(72) Inventor: Dennis W. Johnson, Simpsonville, SC (US)

(21) Appl. No.: 13/883,254

(22) PCT Filed: Nov. 4, 2011
(86) PCT No.: PCT/US11/59406

§ 371 Date: Jul. 15, 2013

Related U.S. Application Data
(60) Provisional application No. 61/410,506, filed on Nov. 5, 2010.

(51) Int. Cl. B01D 53/14

(52) U.S. Cl. CPC B01D 53/14
USPC 95/23; 261/76; 95/213; 261/109

(57) ABSTRACT

A diffuser object for a flue gas desulfurization (FGD) absorber is described. The diffuser object is placed in a high flue gas velocity zone inside the absorber in order to better distribute the flue gas and improve absorption efficiency. A method of improving absorption efficiency in a FGD absorber is also described. The method involves identifying high and low velocity zones within the absorber and positioning diffuser objects within the high velocity zones in a non-packed manner. The placement of the diffuser objects and configuration of the objects are calculated to equalize flow rates within the absorber.

This application claims the benefit of priority to U.S. patent provisional application Ser. No. 61/410,506, filed on Nov. 5, 2010.

### FIELD OF THE INVENTION

The field of the invention is flue gas distribution.

### BACKGROUND

Fossil fuel combustion is an important source of power generation, and provides a major portion of the world's power demands. Unfortunately, fossil fuel combustion is also a major contributor of pollutants to the atmosphere and environment. The exhaust gases that result from burning fossil fuels, called “flue gases,” contain many harmful air pollutants, such as nitrogen oxides, sulfur dioxide, volatile organic compounds and heavy metals.

Flue gas desulfurization (FGD) is the process of removing sulfur dioxide (SO₂) from exhaust flue gases. Various FGD methods are known. In one method, called “wet scrubbing,” the flue gas is brought into contact with a slurry having a scrubbing reagent capable absorbing pollutants from the gas. One way to bring the flue gas and slurry into contact with one another is by spraying the slurry in a tower, commonly referred to as an absorber, and letting the flue gas rise up the tower through the mist of slurry. The mist droplets absorb sulfur dioxide from the flue gas and collect at the bottom of the absorber. This method is referred to herein as “wet scrubbing.”

As used herein, the term “efficiency” with respect to a wet scrubbing process means the amount of pollutant removed from the flue gas per a volume of flue gas passing through the absorber. Efficiency tends to improve as the gas-liquid contact is maximized. Various parameters, such as flue gas flow rate, flue gas distribution, spray coverage, spray pattern, spray angle, and droplet size, can affect the gas-liquid contact. It is relatively simple to control spray conditions, however, flue gas flow rate and distribution can be difficult to control in an economical manner. Flue gas often enters the absorber under turbulent flow, causing high velocity zones throughout the absorber. This is due, in part, to the large pressure drop once the flue gas enters the absorber, and to 90 degree turns in the piping just before the absorber inlet. The turbulent flow creates variable flow rates and uneven flue gas distribution, both of which decrease the gas liquid contact. In addition, the turbulent flow creates non-optimal flow rates: when flue gas velocity is too high, the liquid has less time to absorb pollutants from the gas; when the flue gas velocity is too low, there is not sufficient mixing of the gas and liquid.

Various approaches have been taken to address the issue of uneven flue gas distribution. One approach is to build a taller absorber, allowing the flue gas and the scrubbing reagent more time to mix due to the increased residence time in the tower. However, that approach greatly increases building and operating costs. Another approach is to include more spray nozzles, and spray more slurry into the absorber, thereby increasing the slurry to gas ratio and improving the mass transfer surface area. That approach also requires higher operating costs since more slurry must be pumped and sprayed into the absorber. Other approaches combine both the taller absorber and more spray nozzles. While these approaches help to increase the pollutant removal efficiency of an absorber, they are expensive to implement.

Yet another approach is to place a tray near the bottom of the absorber. U.S. Pat. No. 4,263,021 to Downs and U.S. Pat. No. 5,246,471 to Bhat, for example, teach a tray that spans across the internal diameter of the absorber. FIG. 1 generally depicts the FGD absorber taught in Bhat. Flue gas resulting from the combustion of fossil fuel enters the absorber tower 10 at inlet duct 11, rises through the inside of the absorber, and exits at the top. Nozzles 13 spray a liquid absorbent, such as a limestone slurry, for dissolving and absorbing sulfur dioxide from the flue gas as it rises through the tower. Trays 14 and 16 are disposed in the lower end of the absorber and are sized and dimensioned to span across the internal diameter of the absorber. A close-up perspective view of tray 14 is also shown to the right of tower 10. The close-up shows tray 14 having holes 15 through which the flue gas rises. Partitions 31 create compartments that can fill with gasified liquid masses, providing a barrier through which the rising flue gas can pass. Trays 14 and 16 function to equalize the flow rate and distribution of the flue gas, and increase gas liquid contact.

These and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

While the trays in Downs and Bhat provide a mass transfer device for improving gas liquid contact, this approach creates a large back pressure that can be strenuous on upstream components. Moreover, a tray that spans across the entire horizontal plane of an absorber can be expensive and difficult to install.

U.S. Pat. No. 5,648,022A to Gohara teaches using an inlet that slows down the flue gas as it enters the absorber. However, as with the tray, a custom inlet device can be costly to make and install, and also increases back pressure. Moreover, Gohara fails to eliminate or minimize high and low gas velocity zones within the absorber.

It would be advantageous to provide a solution to maldistribution of flue gas in an absorber by diffusing the high velocity and high pressure zones. By strategically placing diffusers in high velocity zones, back pressure buildup is minimized and the need for installing a tray is reduced or eliminated. US Patent Publication U.S.20080210096 to Crews teaches placing packed targets within an absorber. The targets provide a surface upon which the liquid and gas can impinge, improving mass transfer between the flue gas and liquid. However, this “packing stage” creates back pressure since the targets must be densely packed across the entire cross section of the tower in order to function properly. Further, Crews does not strategically position the targets in high velocity zones in order to decrease velocity of the flue gas in those zones to improve flue gas distribution.

Downs, Bhat, Gohara, Crews, and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

Thus, there is still a need for apparatus, systems and methods for equalizing flue gas distribution and achieving optimal flue gas flow rates in an FGD absorber.

### SUMMARY OF THE INVENTION

The inventive subject matter provides apparatus, systems, and methods in which diffuser objects are placed within high flue gas velocity zones within a flue gas desulfurization (FGD) absorber. The diffuser objects are configured with a specific size/shape/design and positioned such that flue gas flow rates are better distributed throughout the absorber. The diffuser objects are positioned in a non-packed manner, thus diffusing high velocity zones while simultaneously increasing flow through low velocity zones.

As used herein, the term “non-packed” means the diffuser objects do not span across the entire cross section of the absorber. Thus, the trays taught in Bhat and Downs, and the packing stage taught in Crews, would not be considered a “non-packed configuration,” since they span across the entire cross section of the absorber. The cross section of the absorber is defined as a plane orthogonal to the long dimension of the flue gas absorber and located within the absorbing region.

As used herein, the term “high velocity zone” means an area within a horizontal cross section of the absorber where the velocity of the flue gas is at least 20 ft/sec, and a “very high velocity zone” means an area within a horizontal cross section of the absorber where the velocity of the flue gas is at least 30 ft/sec.

From a method perspective, absorption efficiency in a flue gas desulfurization absorber can be improved by (i) identifying and distinguishing high and low velocity zones of a flue gas within the absorber, and (ii) positioning non-tray diffuser objects within the high velocity zones in a manner calculated to equalize flow rates within the high and low velocity zones. “Calculated” means the configuration, size, dimension, orientation, location, number, and other various characteristics of diffuser objects, are strategically designed to better equalize the overall flue gas distribution within the absorber.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a drawing of a prior art flue gas desulfurization absorber.

FIG. 2 is a bottom view of a cross section of an absorber, showing the results of computational fluid dynamics analysis.

FIG. 3 is a side view of a cross section of an absorber, showing the results of computational fluid dynamics analysis.

FIG. 4 is a perspective view of one embodiment of a flue gas diffuser object.

FIG. 5 is a perspective view of another embodiment of a flue gas diffuser object.

FIG. 6 is a schematic of different shapes and geometries that can be used for flue gas diffuser objects.

FIG. 7 is a flue gas desulfurization absorber with a plurality of flue gas diffuser objects installed therein.

### DETAILED DESCRIPTION

One should appreciate that the disclosed devices and techniques provide many advantageous technical effects including improving flue gas distribution in a FGD absorber. Specifically, the disclosed devices and techniques target high velocity zones of flue gas flow within an absorber.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

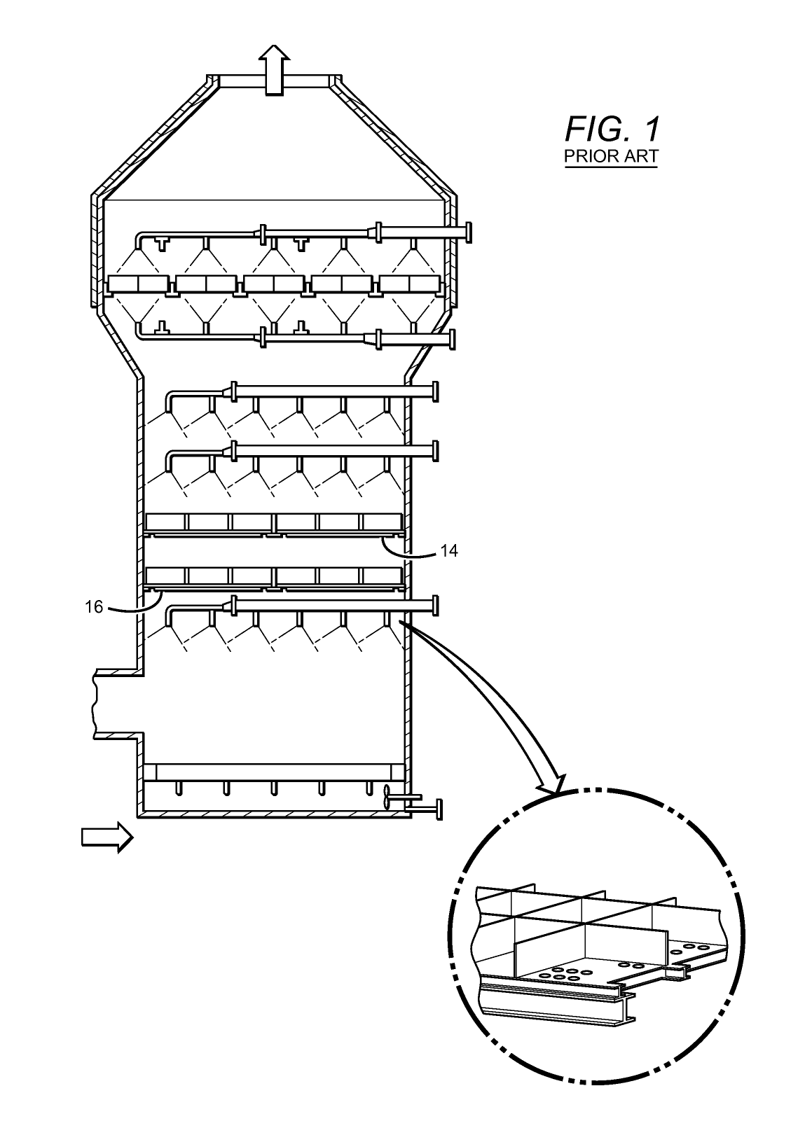

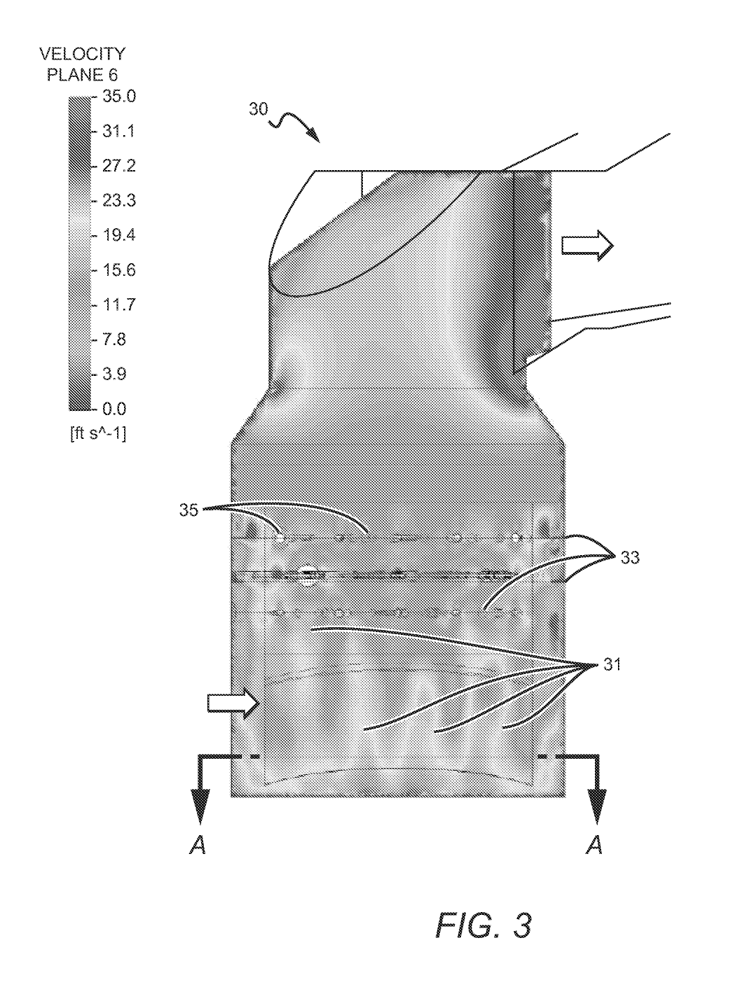

FIG. 1 shows a prior art drawing of a flue gas desulfurization (FGD) absorber (see FIGS. 1 and 3 of U.S. Pat. No. 5,246,471 to Bhat et al.). The absorber in FIG. 1 has trays 14 and 16, which are included for the purpose of improving flue gas distribution within the absorber. The trays span across the entire cross section of the absorber, thus causing a back pressure just upstream from the trays. This back pressure creates strain on upstream components (e.g., fans). The trays are also expensive and do not specifically target high velocity zones.

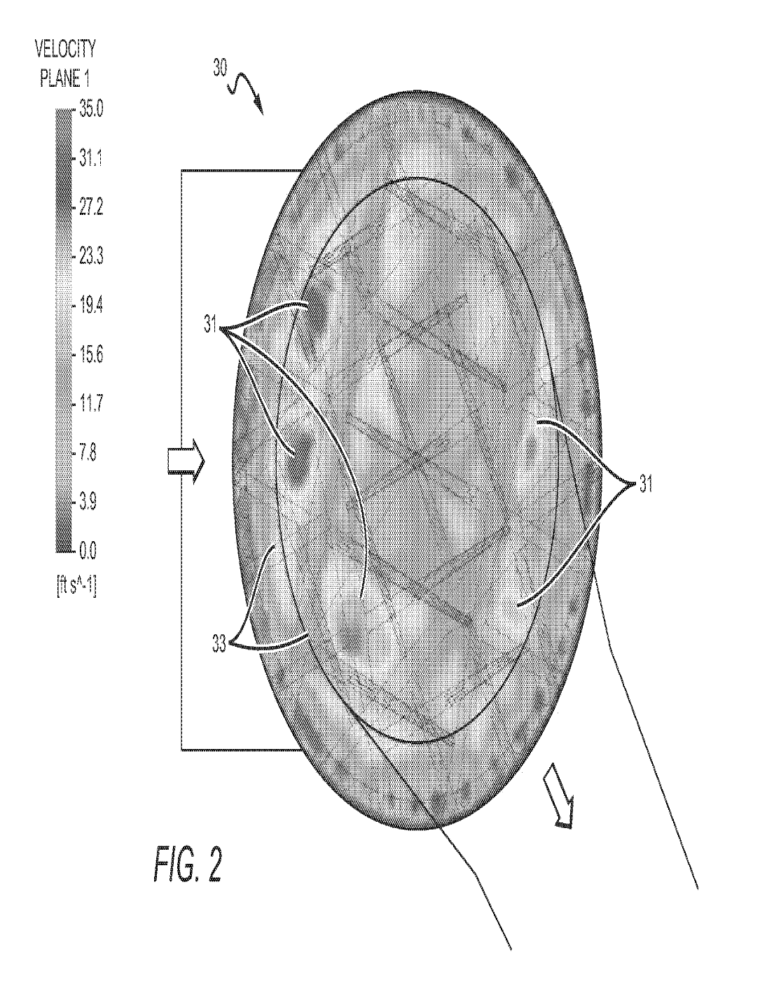

High and low velocity zones within an absorber can be identified and distinguished using various sensors, instruments, and applications. In one embodiment of the invention, high velocity zones are identified by using a computational fluid dynamics (CFD) software program. CFD comprises using numerical methods and algorithms in order to simulate and analyze fluid flow. FIG. 2 is a bottom view of a cross section A-A (see FIG. 3) of the absorber in FIG. 3, showing the results of CFD analysis. FIG. 3 is a side view of an absorber 30 having spray headers 33 and spray nozzles 35. The spray headers 33 deliver the slurry to be sprayed into absorber 30 via nozzles 35. The color pattern within absorber 30 shows the results of CFD analysis. High velocity zones 31 are indicated by red and orange color and are zones in which the flue gas is flowing at higher velocities (>21 ft/s). The green, teal, and blue colors indicate lower velocities (0-20 ft/s) according to the color scale shown to the left of the absorber.

In another aspect of the invention, high velocity zones are identified by placing a plurality of sensors within the absorber and monitoring the velocity of the flue gas in different locations within the absorber during operation of the absorber. The plurality of sensors are made of materials appropriate for withstanding temperatures, pressures, and conditions found within the absorber.

In yet another aspect of the invention, high velocity zones are identified by a combination of sensors, physical models, and CFD analysis. The sensors can serve to double check the model and/or CFD results.

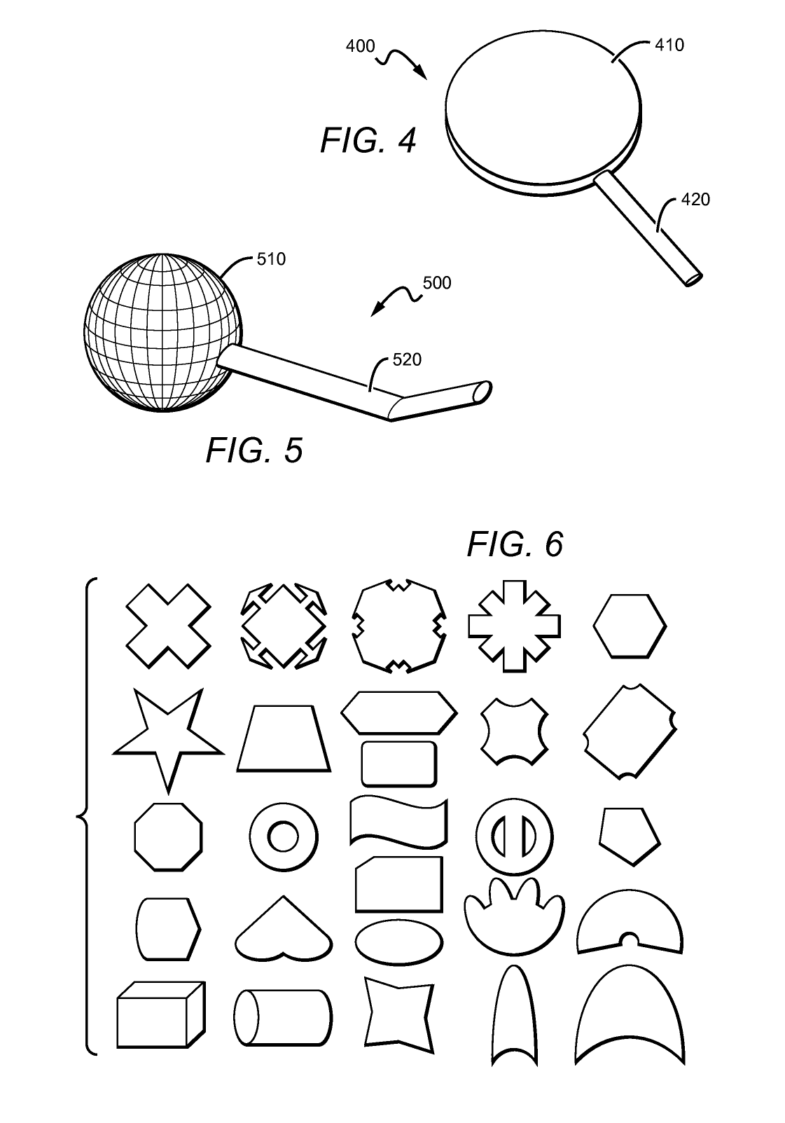

Once high velocity zones have been identified, diffusers can be installed and positioned within the high velocity zones. The diffusers preferably have a surface area that is sized and dimensioned to diffuse a high velocity zone, meaning the flue gas velocity and/or pressure within that zone is reduced. FIG. 4 is a perspective view of diffuser 400. Diffuser 400 has a disc 410 that has the general shape of a disc. The surface area of disc 410 is sized and dimensioned to diffuse a high velocity zone. The exact size and orientation of diffuser 400 will depend on the size and nature of the high velocity zone and the direction of flow. In one embodiment, the surface area of disc 410 is positioned orthogonally to a general directional flow of the flue gas. One of ordinary skill in the art will appreciate that various sizes, shapes, and orientations can be utilized, depending on the nature of the high velocity zone.

The surface area of disc 410 can be sized to occupy the entire cross sectional area of a high velocity zone. It is also contemplated that the surface area of disc 410 can occupy less than 70%, 50%, or even 30% of a hypothetical plane crossing through the high velocity zone. In one embodiment, a plurality of diffusers each having a surface area less than 10% the surface area of the high velocity zone within a plane are disposed in the high velocity zone. Diffuser 400 is a “non-tray” diffuser object, meaning that diffuser 400 is not a tray expanding across the entire cross section of absorber 30.

Diffuser 400 also has an arm 420 that is used to fasten diffuser 400 within an absorber. Fasteners are well known and any fastener suitable for withstanding the conditions inside an absorber is contemplated. In one embodiment, the end of arm 420 is welded to the internal wall of an absorber or to the spray header or spray header supports of the absorber. In another embodiment, arm 420 has holes for receiving a screw or bolt that can be used to attach the end of arm 420 to a bracket inside the absorber. Alternatively, arm 420 could clamp to a spray head or spray header supports within the absorber. Diffuser 400 could also have multiple fasteners.

In one embodiment, arm 420 is removeably installed into an absorber and arm 420 could be flexible for allowing diffuser 400 to be repositionable. Arm 420 could also be configured to expand and contract. Arm 420 is preferably sized, dimensioned, and positioned such that it does not substantially impede or interfere with the slurry mist from coming into contact with the flue gas.

Diffuser 400 can be made of metal, ceramic, composite, polymers, or any material suitable for withstanding the internal environmental conditions of a FGD absorber. The conditions of a FGD absorber can be acidic and abrasive, with chlorides present. Preferably, alloys such as 316LMN, 317LNM, 2205, Hastelloy C-22/C-276, AL6XN, and other alloys that can handle corrosion are used to make the diffusers. Non-alloy diffusers could comprise Teflon®, fiberglass reinforced plastic (FRP), and similar plastics. Diffusers can also comprise ceramic or a composite such as carbon steel lined or coated with plastic, epoxy, elastomers (natural rubber, bromylbutyl rubber, chlorobutyl rubber, silicon, etc.) or other compatible coatings. Plastic materials like polypropylene are also contemplated, but may require ribbing or stiffening and special attachment designs.

FIG. 5 is a perspective view of a diffuser 500. Diffuser 500 has a sphere 510 that has the general shape of a sphere. Sphere 510 is disposed within a high velocity zone in an absorber. Arm 520 is used to install the diffuser within an absorber. Preferably, sphere 510 is hollow and has perforations, allowing flue gas to pass through it. The size of the perforations can be varied in order to control the diffuser's impedance to flue gas flow. In this manner, sphere 510 can be specifically configured to diffuse a unique high velocity zone within an absorber.

FIG. 6 shows other various shapes and objects of a diffuser. The diffuser can comprise a uniform flat plate of various geometric profiles such as polygons, ellipses, and circles. Alternatively, the diffuser can comprise a non-plate form having a non-uniform profile. In one aspect of the invention, a plurality of diffusers are installed within an absorber in order to diffuse a plurality of high velocity zones. Moreover, it is contemplated that a plurality of diffusers can be used to diffuse one high velocity zone.

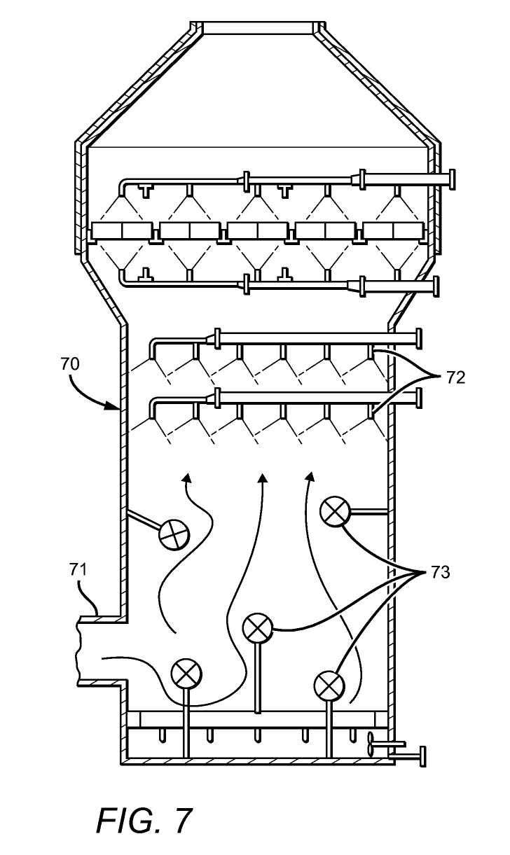

FIG. 7 is the side view of an absorber 70 having an inlet 71 and sprayers 72. Absorber 70 is 52 feet in diameter and has two spray levels but could also include more sprayer levels. As a flue gas enters absorber 70 via inlet 71, the gas comes in contact with an absorbent, such as a limestone slurry, which is sprayed into the absorber 70 via sprayers 72. Diffusers 73, such as the diffusers discussed above, have been strategically placed within various high velocity zones of the flue gas within the absorber. In this manner, flue gas velocity is reduced in high velocity zones, and increased in low velocity zones. Thus, the diffusers provide a means for evenly distributing flue gas throughout the absorption region of the absorber. This approach advantageously cuts back on the costs of installing a tray or a specialized inlet. Moreover, unlike trays and inlets, the diffusers do not create a significant back pressure since flue gas is directed away from high velocity zones and into low velocity zones. The diffusers contemplated herein allow the FGD absorbers to achieve higher efficiency without adding tower height or more spray nozzles.

Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A flue gas absorber, comprising:
an absorbing region having a long dimension through which a flue gas travels in a generally upstream to downstream manner, and a cross section orthogonal to the long dimension that has a high velocity zone and a low velocity zone;
a non-packed plurality of at least first and second non-tray diffuser objects disposed in the high velocity zone in a manner that reduces flow through the high velocity zone and increases flow through the low velocity zone; and
a sprayer that sprays an absorbent into the absorbing region and downstream of at least one of the one of the diffuser objects.

2. The absorber of claim 1 wherein the first object has a geometric shape.

3. The absorber of claim 1 wherein the first object has a non-geometric shape.

4. The absorber of claim 1 wherein the first object comprises a disc.

5. The absorber of claim 1 wherein the first object is made of a metal.

6. The absorber of claim 1 wherein none of the first and second objects are disposed in the lower velocity zone.

7. The absorber of claim 1 wherein the absorber comprises limestone slurry.

8. The absorber of claim 1 wherein the absorber comprises a composition that chemically reacts with at least one of SO_{X} and NO_{X}.

9. The absorber of claim 1 wherein the first object defines a surface area occupying less than 30% of an area of the high velocity zone.

10. A method of improving absorption efficiency in a flue gas desulfurization absorber, comprising;
distinguishing among high and low velocity zones of a flue gas within the absorber; and
positioning non-tray diffuser objects within the high velocity zones in a manner calculated to equalize flow rates within the high and low velocity zones.

11. The method of claim 10 wherein the step of distinguishing among high and low velocity zones comprises identifying at least two of the high velocity zones and at least two of the low velocity zone.

12. The method of claim 10 wherein the step of distinguishing among high and low velocity zones comprises placing a plurality of sensors for measuring gas flow rates inside the absorber.

13. The method of claim 10 wherein the step of distinguishing among high and low velocity zones comprises executing a computational fluid dynamics software program.

14. The method of claim 11 wherein the step of positioning the non-tray diffuser objects comprises using a computational fluid dynamics software program to calculate preferred orientations of the objects.

15. A flue gas diffuser object for a flue gas desulfurization absorber, comprising:
a diffuser object configured to diffuse a high flue gas velocity zone within the absorber;
an elongated member coupled with the diffuser object; and
a fastener coupled with the elongated member and configured to attach the diffuser object to a component of the absorber.

16. The diffuser object of claim 15, wherein the fastener comprises a c-clamp.

17. The diffuser object of claim 15, wherein the fastener comprises a screw and screw holes.

18. The diffuser object of claim 15, wherein the diffuser object comprises a geometric shape.

19. The diffuser object of claim 15, wherein the elongated member has an adjustable length.

20. The diffuser object of claim 15, wherein the component comprises a nozzle.
